(19) United States
(12) Patent Application Publication
(10) Pub. No.: US 2023/0298392 A1
(43) Pub. Date: Sep. 21, 2023

(54) REPLACEMENT TIME CALCULATION SYSTEM AND REPLACEMENT TIME CALCULATION METHOD

(71) Applicant: HONDA MOTOR CO., LTD., Tokyo (JP)

(72) Inventors: Satoshi YOSHIMARU, Tokyo (JP); Kohei MUKAIHARA, Tokyo (JP)

(21) Appl. No.: 18/172,332

(22) Filed: Feb. 22, 2023

(30) Foreign Application Priority Data
Mar. 15, 2022 (JP) 2022-040804

(51) Int. Cl. G07C 5/00; G07C 5/02

(52) U.S. Cl. CPC G07C 5/006; G07C 5/02

(57) ABSTRACT

A consumable part replacement time calculation system includes: a mileage acquirer acquiring mileage in response to an ignition of a movable body being turned on or off; a consumable part consumption degree grasper grasping a consumption status of a consumable part provided in the movable body; an average mileage calculator calculating, when a value of data from the consumable part consumption degree grasper has been restored to an initial value a plurality of times, an average value of mileage between two adjacent restorations to the initial value; and a replacement-time mileage calculator calculating replacement time of the consumable part by dividing total mileage traveled by the movable body by the number of times of the value of the data from the consumable part consumption degree grasper having been restored to the initial value.

This application is based on and claims the benefit of priority from Japanese Patent Application No. 2022-040804, filed on 15 Mar. 2022, the content of which is incorporated herein by reference.

### BACKGROUND OF THE INVENTION

### Field of the Invention

The present invention relates to a replacement time calculation system and a replacement time calculation method.

### Related Art

Conventionally, there has been provided an automobile breakdown prevention support service method and system in which inspection of automotive consumable parts is not performed at time intervals like periodic inspection/maintenance and vehicle inspection but is performed according to mileage of each automobile (see, for example, Patent Document 1).

Patent Document 1: Japanese Patent No. 4079888

### SUMMARY OF THE INVENTION

In the conventional system, when a customer of a vehicle as a movable body defects from a dealer and leaves the dealer for a competitor company, it is not possible to detect the customer, and replacement records and residual statuses of consumable parts of the customer's vehicle. Therefore, it is not possible to grasp replacement intervals of the consumable parts. Therefore, it is difficult to perform effective one-to-one sales promotion activities for customers.

An object of the present invention is to, for the purpose of improving energy efficiency by appropriate replacement of an automotive consumable part, provide a replacement time calculation system and a replacement time calculation method capable of grasping replacement records and a residual status of a consumable part of a vehicle of a customer who has defected from a dealer and left the dealer for a competitor company and calculating the next replacement time of the consumable part.

In order to achieve the above object, the present invention provides a consumable part replacement time calculation system, the consumable part replacement time calculation system including: a mileage acquirer (for example, a mileage acquirer 103 described later) acquiring mileage in response to an ignition of a movable body (for example, vehicles 200-1 to 200-n described later) being turned on or off; a consumable part consumption degree grasper (for example, an engine oil residual rate acquirer 101 described later) grasping a consumption status of a consumable part (for example, engine oil described later) provided in the movable body; an average mileage calculator (for example, an average mileage calculator 114 described later) calculating, when a value of data from the consumable part consumption degree grasper has been restored to an initial value a plurality of times, an average value of mileage between two adjacent restorations to the initial value; and a replacement-time mileage calculator (for example, a replacement-time mileage calculator 104 described later) calculating replacement time of the consumable part by dividing total mileage traveled by the movable body by the number of times of the value of the data from the consumable part consumption degree grasper having been restored to the initial value. Further, the present invention provides a consumable part replacement time calculation method, the consumable part replacement time calculation method including the steps of: acquiring mileage in response to an ignition of a movable body being turned on or off (for example, step S101 described later); grasping a consumption status of a consumable part provided in the movable body (for example, step S102 described later); calculating, when a value of data of the consumption status of the consumable part has been restored to an initial value a plurality of times, an average value of mileage between two adjacent restorations to the initial value (for example, step S104 described later); and calculating replacement time of the consumable part by dividing total mileage traveled by the movable body by the number of times of the value of the data of the consumption status of the consumable part having returned to the initial value (for example, step S104 described later).

Further, the consumable part replacement time calculation system includes a position acquirer (for example, a position acquirer 102 described later) acquiring a position of the movable body at the time of replacement of the consumable part. Further, the consumable part replacement time calculation method includes a step of acquiring a position of the movable body at the time of restoration to the initial value.

Further, the consumable part replacement time calculation system includes a data receiver (for example, a data receiver 105 described later) receiving data from the mileage acquirer, the data from the consumable part consumption degree grasper and data from the position acquirer. Further, the consumable part replacement time calculation method includes a step of receiving data of the mileage, the data of the consumption status of the consumable part and data of a position of the movable body at the time of restoration to the initial value (for example, step S104 described later).

Further, the data receiver is provided with general map information and a replacement place register with which places where replacement of the consumable part is possible are registered in advance (for example, a replacement place register 106 described later). In the receiving step, it is possible to use general map information and information with which places where replacement of the consumable part is possible are registered.

The replacement-time mileage calculator calculates the replacement time of the consumable part as at least one selected from the mileage of the movable body and a date. The consumable part replacement time calculation method includes a step of calculating the replacement time of the consumable part as at least one selected from the mileage of the movable body and a date (for example, step S104 described later).

According to the present invention, it is possible to provide a replacement time calculation system and a replacement time calculation method capable of grasping replacement records and a residual status of a consumable part of a vehicle of a customer who has defected from a dealer and left the dealer for a competitor company and calculating the next replacement time of the consumable part.

### BRIEF DESCRIPTION OF THE DRAWINGS

FIG. 1 is a diagram showing a system according to an embodiment of the present invention;

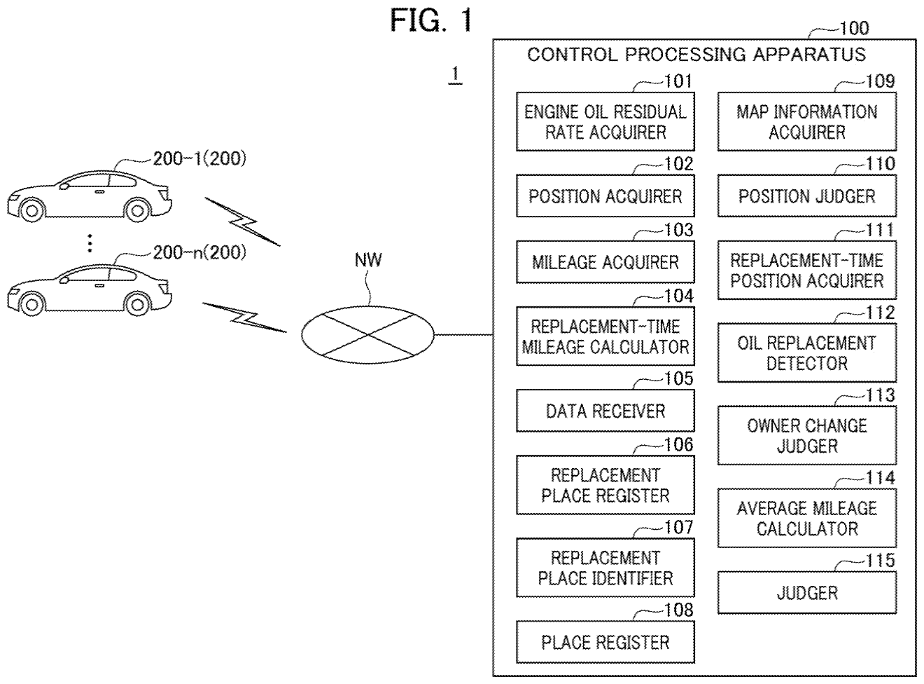

FIG. 2 is a flowchart showing a process in the system according to the embodiment of the present invention;

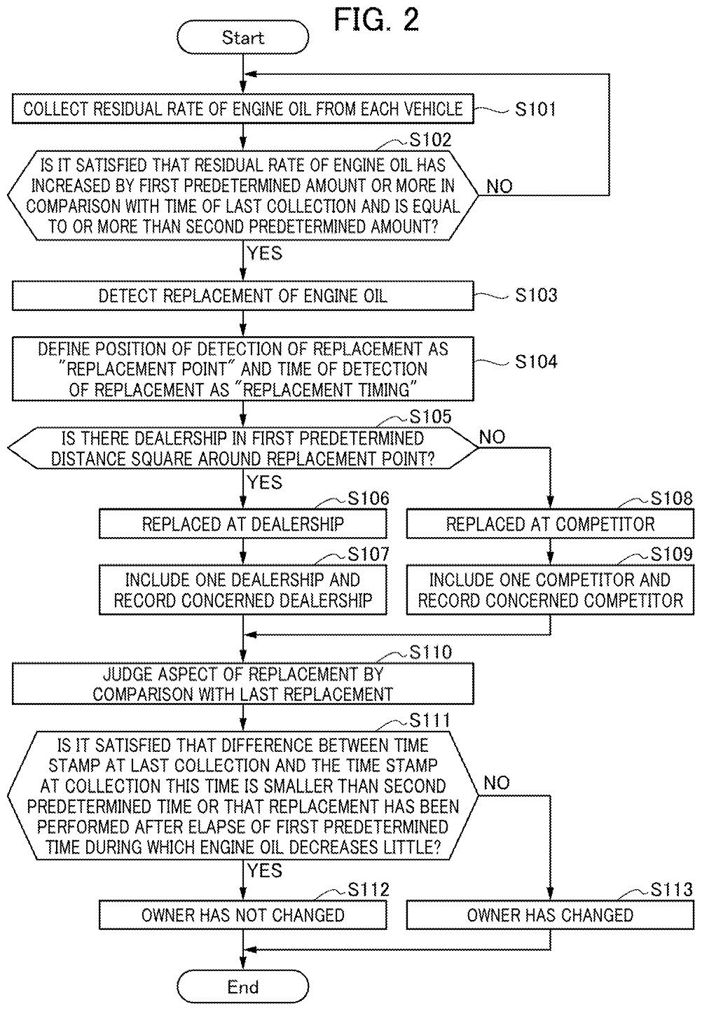

FIG. 3 shows a graph showing a relationship between the residual rate of engine oil and mileage of a vehicle;

FIG. 4 shows a graph showing a first example of the relationship between the residual rate of engine oil and mileage in a case where a vehicle owner has changed;

FIG. 5 shows a graph showing a second example of the relationship between the residual rate of engine oil and mileage in the case where a vehicle owner has changed;

FIG. 6 is a diagram for explaining a positional relationship between a place where engine oil of a vehicle is replaced and a dealership of the vehicle;

FIG. 7 is a diagram for explaining a positional relationship between a vehicle dealership and competitors and the like around the vehicle dealership;

FIG. 8 is a diagram showing vehicles for which engine oil has been replaced at a vehicle dealership and the competitors and the like around the vehicle dealership and the number of days until the next engine oil replacement for the vehicles;

FIG. 9 is a diagram showing the rate of customer defection from vehicle dealerships for each area;

FIG. 10 shows graphs showing characteristics of vehicle engine oil replacement timing in one area;

FIG. 11 shows graphs showing difference between the characteristics of the vehicle engine oil replacement timing in different areas; and

FIG. 12 shows graphs showing the number of vehicles for which engine oil has been replaced for each day of the week, at a vehicle dealership and competitors and the like around the vehicle dealership.

### DETAILED DESCRIPTION OF THE INVENTION

An embodiment of the present invention will be described below in detail with reference to drawings.

A system 1 of the embodiment is provided with a control processing apparatus 100 and vehicles 200-1 to 200-n (n is an integer satisfying n>1). The control processing apparatus 100 and each of the vehicles 200-1 to 200-n are mutually communicable via a network NW. The network NW includes the Internet, a WAN (wide area network), a LAN (local area network), a public line, a dedicated line and the like.

In the present embodiment, each of the vehicles 200-1 to 200-n is an engine vehicle that travels with an internal-combustion engine as a drive source or a hybrid vehicle that travels with an engine and a motor as drive sources. The vehicles 200-1 to 200-n are stopped in parking lots used by owners of the vehicles 200-1 to 200-n or at dealerships or competitors where engine oil is replaced for the vehicles 200-1 to 200-n.

Each of the vehicles 200-1 to 200-n is a vehicle equipped with a wireless communication function, which is called a connected car. By the vehicles 200-1 to 200-n being connected to the network NW, pieces of vehicle data acquired from the vehicles 200-1 to 200-n are inputted to the control processing apparatus 100 via the network NW, and various analyses about the vehicles 200-1 to 200-n are made. The pieces of vehicle data include, for example, the places, mileages, residual rates of engine oil and the like of the vehicles 200-1 to 200-n at the time of the ignitions of the vehicles 200-1 to 200-n being turned on, respectively. In the description below, the vehicles 200-1 to 200-n will be appropriately referred to as the vehicles 200.

The control processing apparatus 100 is realized by an apparatus such as a personal computer, a server or an industrial computer. The control processing apparatus 100 includes, for example, an engine oil residual rate acquirer 101, a position acquirer 102, a mileage acquirer 103, a replacement-time mileage calculator 104, a data receiver 105, a replacement place register 106, a replacement place identifier 107, a place register 108, a map information acquirer 109, a position judger 110, a replacement-time position acquirer 111, an oil replacement detector 112, an owner change judger 113, an average mileage calculator 114 and a judger 115. A consumable part replacement-time position identification system, a replacement time calculation system, a position judgment system and an owner change detection system are configured with the above components.

These systems are realized, for example, by a hardware processor such as a CPU (central processing unit) executing a program (software) stored in a storage not shown. A part or all of these functional units may be realized by hardware (including circuitry) such as an LSI (large scale integration), an ASIC (application specific integrated circuit), an FPGA (field-programmable gate array) or a GPU (Graphics processing unit) or may be realized by cooperation by software and hardware.

The storage not shown in which the program is stored is realized by an HDD (hard disk drive), a flash memory, a RAM (random access memory), a ROM (read-only memory) or the like. The program may be stored in a removable storage medium (a non-transitory storage medium) such as a DVD or a CD-ROM and installed by being fitted into a drive device. Further, in the storage, information about each vehicle 200, for example, information including the place, mileage, residual rate of engine oil and the like of the vehicle 200 at the time of the ignition of the vehicle 200 being turned on is stored.

The engine oil residual rate acquirer 101 grasps the residual rate of engine oil as a consumable part of each vehicle 200, which is included in the vehicle data of the vehicle 200 acquired via the network NW.

The position acquirer 102 acquires information about the position (values of the longitude and the latitude) of each vehicle 200, which is a travel position status at the time of the ignition being turned on in the vehicle 200, the information being included in the vehicle data acquired from the vehicle 200. When the ignition is turned on after engine oil is replaced in each vehicle 200, the value of the residual rate of engine oil outputted from the engine oil residual rate acquirer 101 is restored to an initial value, which is a value immediately after engine oil replacement. When the value is restored to the initial value, the oil replacement detector 112 detects that engine oil replacement has been performed, and the replacement-time position acquirer 111 identifies the position of the vehicle 200 as an engine oil replacement position.

More specifically, if the residual rate of engine oil is equal to or more than a second predetermined amount under the premise that the residual rate at the time of the ignition being turned on this time has risen by a first predetermined amount or more in comparison with that at the time of the ignition being turned on in the vehicle 200 last time, it is judged that the value of the residual rate of engine oil has been restored to the initial value, and the oil replacement detector 112 detects that engine oil replacement has been performed in the vehicle 200. Here, the first predetermined amount is an amount of fluctuation at the time of engine oil circulating in the engine of the vehicle 200. The second predetermined amount is an amount in an upper limit status with sufficient engine oil in the vehicle 200, and is an amount corresponding to the initial value by which it is judged that engine oil has been replaced.

The mileage acquirer 103 acquires mileage of each vehicle 200 at the time of the ignition being turned on in the vehicle 200, the mileage being included in the vehicle data acquired from the vehicle 200.

The replacement-time mileage calculator 104 divides total mileage, which is mileage traveled by each vehicle 200, outputted from the mileage acquirer 103, by the number of times of the value of the residual rate of engine oil of the vehicle 200 outputted from the engine oil residual rate acquirer 101 having been restored to the initial value, which is a value immediately after engine oil replacement. Thereby, the replacement-time mileage calculator 104 calculates time to replace engine oil.

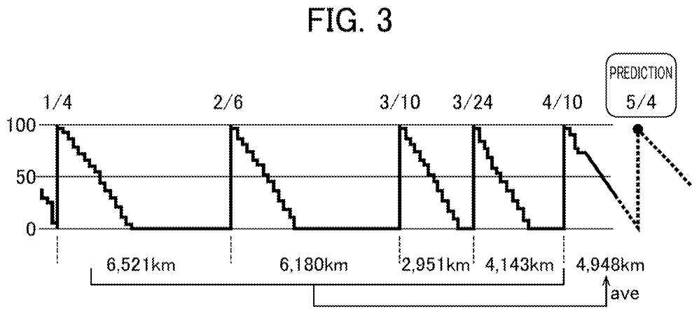

Specifically, the replacement-time mileage calculator 104 acquires the total mileage, which is mileage traveled by each vehicle 200. Further, the replacement-time mileage calculator 104 acquires an average value of mileage traveled between engine oil replacement and the next engine oil replacement, from the average mileage calculator 114. Here, when the value of the residual rate of engine oil of each vehicle 200 outputted from the engine oil residual rate acquirer 101 has been restored to the initial value, which is a value immediately after engine oil replacement, a plurality of times, the average mileage calculator 114 calculates an average value of mileage between restorations to two chronologically adjacent initial values, that is, between consecutive restorations, for the vehicle 200, for example, as indicated by “ave” in FIG. 3 (in FIG. 3, 4,948 km). As the mileage, a value outputted from the mileage acquirer 103 is used. Further, the replacement-time mileage calculator 104 determines average mileage per day of each vehicle 200 by dividing the total mileage by the number of days of use of the vehicle 200. Further, as shown in FIG. 3, the replacement-time mileage calculator 104 determines the most recent mileage traveled by each vehicle 200 after engine oil was replaced most recently by subtracting mileage at the time of the value of the residual rate of engine oil being restored to the initial value most recently from the total mileage of the vehicle 200. Then, the replacement-time mileage calculator 104 determines mileage remaining until the time when the value of the residual rate of engine oil is expected to be restored to the initial value next time, from the current total mileage, by subtracting the value of the most recent mileage from the average value of mileage of the vehicle 200 outputted from the average mileage calculator 114. Then, the replacement-time mileage calculator 104 divides the remaining mileage by the average mileage per day to determine the number of days remaining until the time when the value of the residual rate of engine oil is expected to be restored to the initial value next time. A date expected to be a date of the next engine oil replacement is determined (May 4 in FIG. 3).

The data receiver 105 receives data of the residual rate of engine oil of each vehicle 200, from the engine oil residual rate acquirer 101, data of mileage of each vehicle 200 at the time of the ignition being turned on in the vehicle 200, from the position acquirer 102, and data of mileage of each vehicle 200 at the time of the ignition being turned on in the vehicle 200, which is included in the vehicle data acquired from the vehicle 200, from the mileage acquirer 103.

Further, the data receiver 105 is provided with a map information acquirer 109 provided with general map information including ordinary map information such as transportation means, buildings and geographical features, and a replacement place register 106 with which places where engine oil can be replaced are registered in advance. The general map information and the places are stored in a storage medium not shown.

Further, the data receiver 105 is provided with the owner change judger 113. The owner change judger 113 judges whether the owner of each vehicle 200 has changed or not by comparing the residual rate of engine oil and position of the vehicle 200 at the time of the engine oil being replaced last time with the residual rate of engine oil and position of the vehicle 200 at the time of the engine oil being replaced this time.

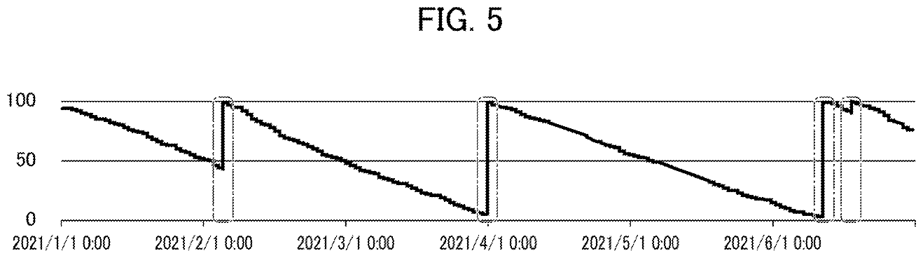

More specifically, the owner change judger 113 detects that the owner of the vehicle 200 has not changed subject to a requirement being satisfied that engine oil replacement positions are the same, and time between the engine oil replacement last time and the engine oil replacement this time is longer than a first predetermine time in the above comparison. Here, as the first predetermined time, for example, the number of days smaller than half of the number of days corresponding to the average value of mileage outputted from the average mileage calculator 114 can be used. If the requirement is not satisfied, it means that the owner of the vehicle 200 changed, and, even though not many days had passed after engine oil replacement by the previous owner, engine oil replacement was performed to sell the vehicle 200 as a used car, as shown by two parts surrounded by dashed lines in the right end of FIG. 5. In FIG. 5, though the horizontal axis indicates mileage of the vehicle 200, dates and time are also shown along the horizontal axis.

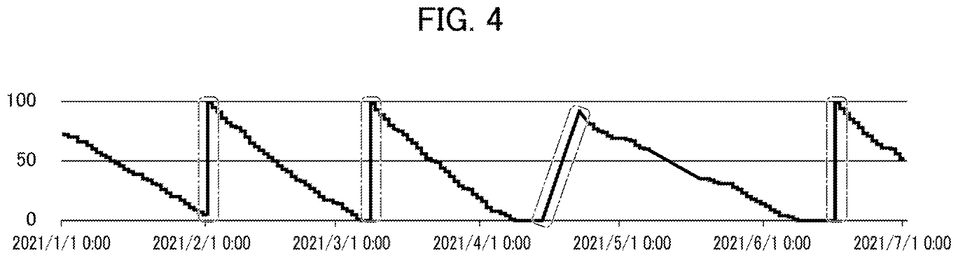

Further, the owner change judger 113 detects that the owner of the vehicle 200 has not changed subject to a requirement being satisfied that a difference between the time stamp of the ignition being turned on immediately before engine oil replacement and the time stamp of the ignition being turned on immediately after the engine oil replacement is less than a second predetermined time in the above comparison. As the second predetermined time, for example, a week or the like can be used. As shown in FIG. 4, if the requirement is not satisfied, and the owner has changed, the rise of the graph is inclined as shown by the third part from the left, among parts surrounded by dashed lines, in comparison with the rises of the graph in the other parts. This means that the owner of the vehicle 200 has changed, and the vehicle 200 has been in a state of being sold as a used car after engine oil replacement or the like. In FIG. 4, though the horizontal axis indicates mileage of the vehicle 200, dates and time are also shown along the horizontal axis similarly to FIG. 5.

The replacement place identifier 107 identifies a place where engine oil has actually been replaced, using information about the places registered with the replacement place register 106. Specifically, first, the sameness between the values of positions of the places registered with the replacement place register 106 and the value of a position when the position has been identified by the replacement place identifier 107 is judged by a judger 115.

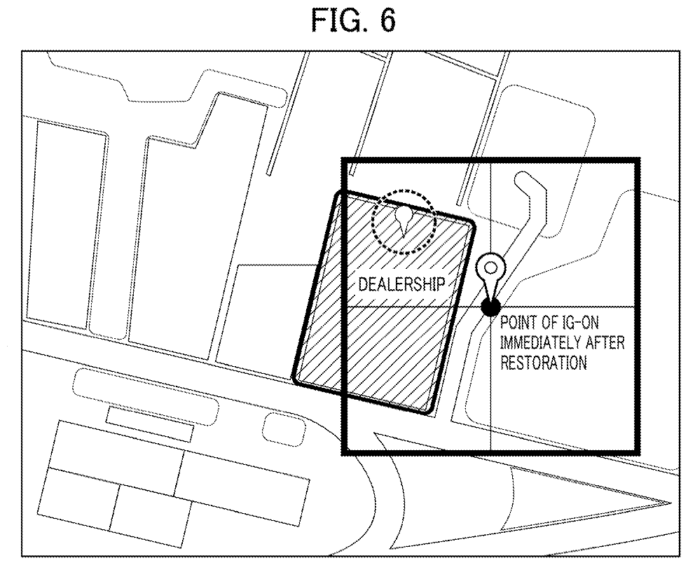

Next, from information about the position of the place of each vehicle 200 from the position acquirer 102, the replacement place identifier 107 judges whether or not there is a dealership or the like registered with the replacement place register 106, for example, in a range of a first predetermined distance square (a range surrounded by a square in FIG. 6) around the position of a place indicated by a black point where a pin stands in FIG. 6. Here, the first predetermined distance is a distance within which a building of a dealership registered with the replacement place register 106 as the dealership of the vehicle 200, where engine oil is replaced, is included. If it is judged that there is a dealership in the first predetermined distance square around a replacement point as shown in FIG. 6, the replacement place identifier 107 identifies the dealership as a place where engine oil has actually been replaced. Then, the judger 115 judges whether the value of the position of any of the places registered with the replacement place register 106 and the value of a position identified by the replacement place identifier 107 in the case of the position being identified by the replacement place identifier 107 are the same or not. If the judger 115 judges that the values are the same, the place registered with the replacement place register 106 is registered as a place where engine oil has actually been replaced.

If there is not a registered place corresponding to the identified place, the position judger 110 compares the position of the place of the vehicle 200 with positions of places of competitors and the like included in the general map information of the map information acquirer 109 to judge an accurate position of the vehicle 200. Then, the map information acquirer 109 adds the judged accurate position to the general map information of the map information acquirer 109 as a new engine oil replacement place of the vehicle 200 from the position acquirer 102 and updates the general map information. The place register 108 registers the place with the replacement place register 106 as a competitor that performs at least one selected from sales, maintenance and management of the vehicle 200.

Next, a consumable part replacement-time position identification method, a replacement time calculation method, a position judgment method and an owner change detection method implemented by control of the control processing apparatus 100 will be described. First, at step S101, the engine oil residual rate acquirer 101 of the control processing apparatus 100 collects the residual rate of engine oil from each vehicle 200. Then, the process of the control processing apparatus 100 proceeds to step S102.

At step S102, the control processing apparatus 100 judges whether or not the residual rate of engine oil received from the engine oil residual rate acquirer 101 by the data receiver 105 has increased by the first predetermined amount or more in comparison with the residual rate at the last collection and is equal to or more than the second predetermined amount.

If, at step S102, the control processing apparatus 100 judges that the residual rate of engine oil has increased by the first predetermined amount or more in comparison with the residual rate at the last collection and is equal to or more than the second predetermined amount (step S102: YES), then the process of the control processing apparatus 100 proceeds to step S103. If the control processing apparatus 100 judges that the residual rate of engine oil has increased by the first predetermined amount or more in comparison with the residual rate at the last collection but is not equal to or more than the second predetermined amount (step S102: NO), then the process of the control processing apparatus 100 returns to step S101.

At step S103, the oil replacement detector 112 of the control processing apparatus 100 detects that engine oil replacement has been performed, and the replacement-time position acquirer 111 identifies the position of the vehicle 200 where the engine oil replacement has been performed, as an engine oil replacement position. Then, the process of the control processing apparatus 100 proceeds to step S104.

At step S104, the control processing apparatus 100 defines the position at which the engine oil replacement has been detected at the time of the ignition being turned on in the vehicle 200 and which has been received by the data receiver 105 from the position acquirer 102, as “a replacement point (a replacement position, a replacement place)”, and defines the time when the engine oil replacement has been detected as “a replacement timing (replacement time)”. The average mileage calculator 114 calculates an average value of mileage of the vehicle 200 for which engine oil replacement has been performed. By acquiring mileage of the vehicle 200 at the time of the ignition being turned on in the vehicle 200, from the mileage acquirer 103, the replacement-time mileage calculator 104 determines the number of days remaining until the time when the value of the residual rate of engine oil is expected to be restored to the initial value next time. Then, the date when the value of the residual rate of engine oil is expected to be restored to the initial value next time is stored into a storage medium not shown. Then, the process of the control processing apparatus 100 proceeds to step S105.

At step S105, an engine oil replacement place is identified by the replacement place identifier 107 of the control processing apparatus 100, and the judger 115 of the control processing apparatus 100 judges the sameness between the values of the positions of the places registered with the replacement place register 106 and the value of the position of the place in the case of the place being identified by the replacement place identifier 107. That is, if it is judged that there is a dealership in the first predetermined distance square around the engine oil replacement point (step S105: YES), the process of the control processing apparatus 100 proceeds to step S106. If it is judged that the dealership does not exist in the first predetermined distance square around the engine oil replacement point (step S105: NO), the process of the control processing apparatus 100 proceeds to step S108.

At step S106, the control processing apparatus 100 judges that the place where engine oil replacement has been performed is the dealership. Then, the process of the control processing apparatus 100 proceeds to step S107. At step S107, the control processing apparatus 100 includes one piece of data to the effect that engine oil replacement has been performed for the vehicle 200 at the dealership, into the replacement place register 106 and records the dealership. Then, the process of the control processing apparatus 100 proceeds to step S110.

At step S108, the control processing apparatus 100 judges that the place where engine oil replacement has been performed is not a dealership but a competitor. Then, the process of the control processing apparatus 100 proceeds to step S109. At step S109, the control processing apparatus 100 includes one piece of data to the effect that engine oil replacement has been performed for the vehicle 200 at the competitor, into the replacement place register 106 and registers the competitor. Then, the map information acquirer 109 adds an accurate position judged by the position judger 110 to the general map information of the map information acquirer 109 as a new engine oil replacement place, based on the position of each vehicle 200 from the position acquirer 102 and updates the general map information.

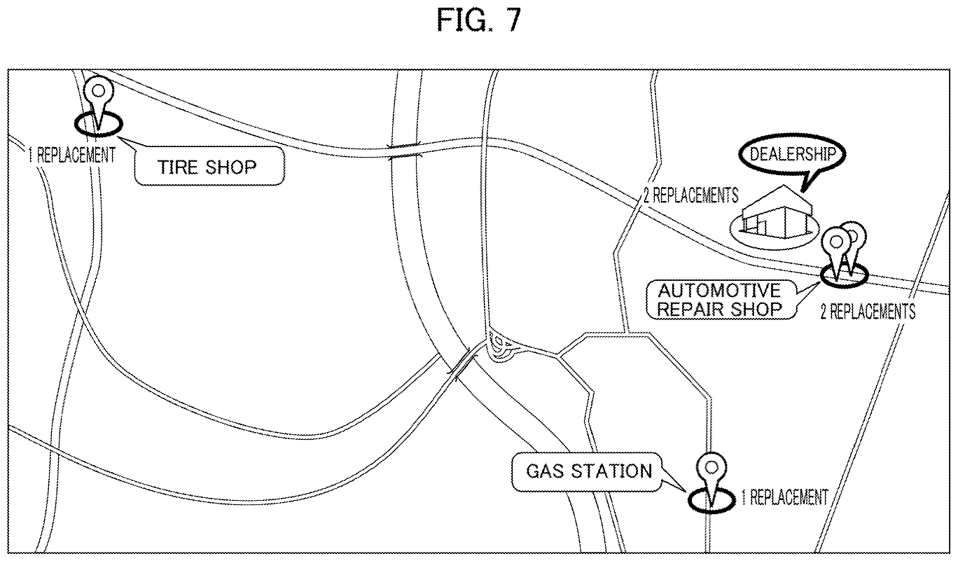

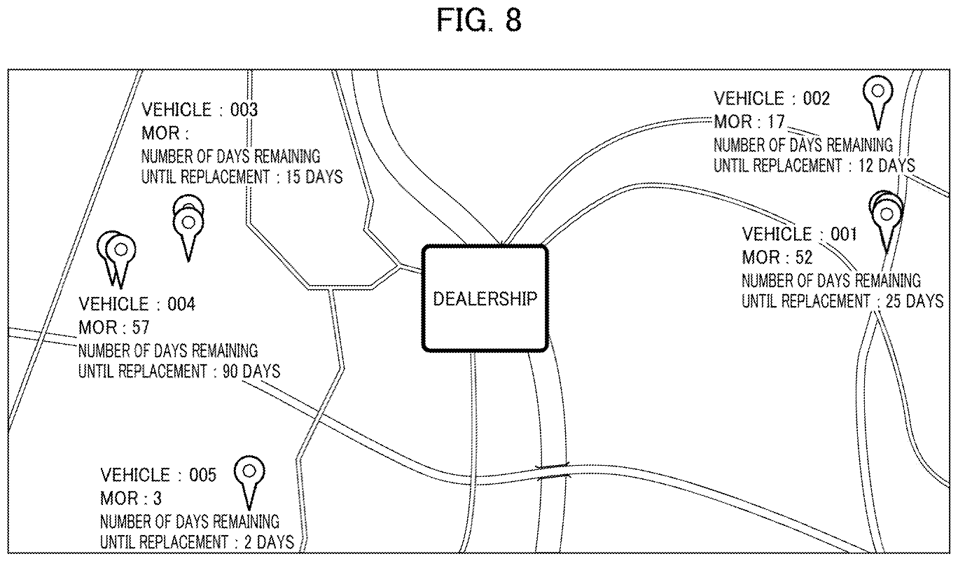

Specifically, as shown in FIG. 7, the number of engine oil replacements performed at competitors such as an automotive repair shop, a tire shop and a gas station are registered so as to be displayed on a map together with the dealership. Further, for example, as shown in FIG. 8, vehicle numbers of the vehicles 200 (for example, “Vehicle: 001” and the like), values of the residual rates of engine oil (for example, “MOR: 52” and the like) and the number of days until engine oil is to be replaced in the vehicles 200 next time (for example, “Number of days remaining until replacement: 25 days” and the like) are recorded so that they can be displayed on the map. Then, the process of the control processing apparatus 100 proceeds to step S110. As for display on the map, expected replacement dates when engine oil is to be replaced next time may also be described in addition to the above.

At step S110, the control processing apparatus 100 compares a place where engine oil was replaced for the vehicle 200 last time and the place where engine oil has been replaced this time. Table 1 shows a specific example.

TABLE 1

| | | LAST TIME | | |
|---|---|---|---|---|
| | | | | SELF |
| | | | COMPET- | PROCURE- |
| | | DEALERSHIP | ITOR | MENT |
| THIS | DEALERSHIP | MANAGE- | CAPTURED | CAPTURED |
| TIME | | MENT KEPT | | |
| | COMPETITOR | GOT OUT | CONTINUED | CONTINUED |
| | | THIS TIME | TO BE OUT | TO BE OUT |
| | SELF | GOT OUT | CONTINUED | CONTINUED |
| | PROCURE- | THIS TIME | TO BE OUT | TO BE OUT |
| | MENT | | | |

That is, if engine oil replacement was performed at a dealership last time, and engine oil replacement has also been performed at a dealership this time, a status of “Management kept” indicating a state that management of the vehicle 200 by the dealer is continued is registered with the replacement place register 106. If engine oil replacement was performed at a dealership last time, but engine oil replacement has been performed at a competitor or by the owner himself this time, a status of “Got out this time” indicating a state that the vehicle 200 has got out of the management by the dealer at the time of the engine oil replacement this time, is registered with the replacement place register 106. If engine oil replacement was performed at a competitor or by the owner himself last time, but engine oil replacement has been performed at the dealership this time, a status of “Captured” indicating a state that management of the vehicle 200 by the dealer is to be performed again, is registered with the replacement place register 106. If engine oil replacement was performed at a competitor or by the owner himself last time, and engine oil replacement has also been performed at a competitor or by the owner himself this time, a status of “Continue to be out” indicating a state that the vehicle 200 is still out of the management by the dealer, is registered with the replacement place register 106. Then, the process of the control processing apparatus 100 proceeds to step S111.

At step S111, the owner change judger 113 of the control processing apparatus 100 judges whether the replacement has been performed after elapse of the first predetermined time during which engine oil decreases little or whether a difference between the time stamp at the collection last time and the time stamp at the collection this time is less than the second predetermined time.

That is, in the above comparison, the owner change judger 113 judges whether or not the engine oil replacement positions (replacement places) are the same, and time between the engine oil replacement last time and the engine oil replacement this time is longer than the first predetermined time. Further, the owner change judger 113 judges whether or not a difference between the time stamp at the time of the ignition being turned on before the engine oil replacement and the time stamp at the time of the ignition being turned on immediately after the engine oil replacement is less than the second predetermined time.

If the results are positive in any of the judgments (S111: YES), the process of the control processing apparatus 100 proceeds to step S112. If the results are negative in any of the judgments (S111: NO), the process of the control processing apparatus 100 proceeds to step S113.

At step S112, the owner change judger 113 of the control processing apparatus 100 records that the owner has not changed, to a recording medium not shown. Then, the process of the control processing apparatus 100 ends.

At step S113, the owner change judger 113 of the control processing apparatus 100 records that the owner has changed, to the recording medium not shown. Then, the process of the control processing apparatus 100 ends.

According to the present embodiment, the following effects are obtained. In the present embodiment, the residual rate indicating a consumption status of engine oil as a consumable part of each vehicle 200 is grasped; a position as a travel position status is acquired in response to the ignition of the vehicle 200 being turned on; and data of the residual rate of the engine oil and data of the position are received. Then, based on the travel status of the vehicle 200, the position of the vehicle 200 is identified if the value of the data of the residual rate of engine oil is restored to the initial value.

Thereby, if the value of the data of the residual rate of engine oil is restored to the initial value, it becomes possible to identify the position of a place where the value has been restored. Therefore, by regarding the position of the place where the value has been restored as the position of an engine oil replacement place, it is possible to grasp an accurate market share. Further, it becomes possible to know competitors where engine oil replacement is performed and understand customer sentiment; it becomes possible to recapture customers who have left, by an optimal approach; and, moreover, it becomes possible to improve the parts business income of the manufacturer of the vehicles 200.

Further, in the present embodiment, in the process for identifying the position of each vehicle 200, the data receiver 105 can use general map information and information with which places where engine oil can be replaced are registered. Thereby, it becomes possible to identify a position where engine oil has actually been replaced for each vehicle 200 on the general map information, comparing the position with the general map information.

Further, in the present embodiment, in the process for identifying the position of each vehicle 200, the replacement place identifier 107 identifies a place where engine oil has actually been replaced, from the information with which the places where engine oil can be replaced are registered. Thereby, it becomes possible to grasp whether or not the engine oil replacement has been performed, at any of the already registered places where engine oil can be replaced.

Further, in the present embodiment, the judger 115 judges the sameness between the values of the information with which the places where engine oil can be replaced are registered and the value of information about the place where engine oil has actually been replaced. Thereby, it becomes possible to grasp whether or not engine oil replacement has been performed at an already registered place where engine oil can be replaced.

Further, in the present embodiment, mileage is acquired in response to the ignition of each vehicle 200 being turned on; the residual rate of engine oil provided in the vehicle 200 is grasped; if the value of data of the residual rate of engine oil has been restored to the initial value a plurality of times, an average value of mileage between two adjacent restorations to the initial value is calculated; and time to replace engine oil is calculated by dividing total mileage traveled by the vehicle 200 by the number of times of the value of the data of the residual rate of engine oil having been restored to the initial value.

Thereby, it becomes possible to, not only when the vehicle 200 is in the management kept status but also in the case of changing to the defection status and in the case of the owner himself having performed engine oil replacement, grasp the residual rate of engine oil, grasp engine oil replacement records and calculate the time to replace engine oil next time. Therefore, it is possible to predict the next replacement time for all the vehicles 200 including vehicles 200 that have defected, for which, conventionally, the time to replace engine oil next time could not be grasped. As a result, it becomes possible to find potential customers who are at an optimal timing of engine oil replacement around shops of the dealer and competitors or the like, and it becomes possible to realize increased sales of engine oil as a part, by developing an efficient sales promotion approach.

Further, by detection of a position in response to the ignition of each vehicle 200 being turned on, it becomes possible to grasp the customer's living area.

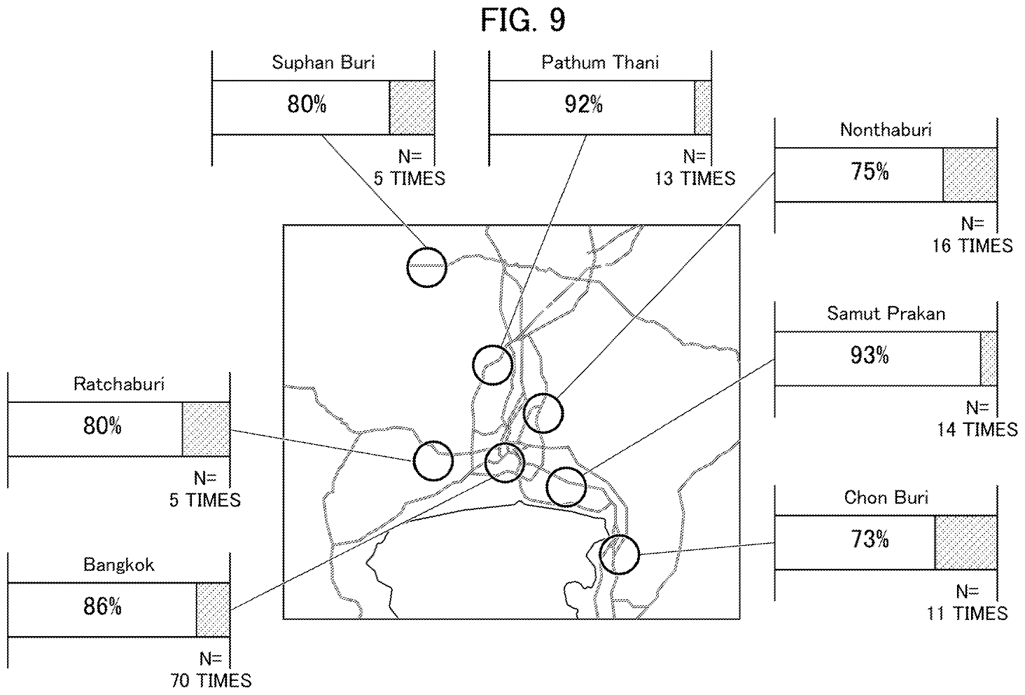

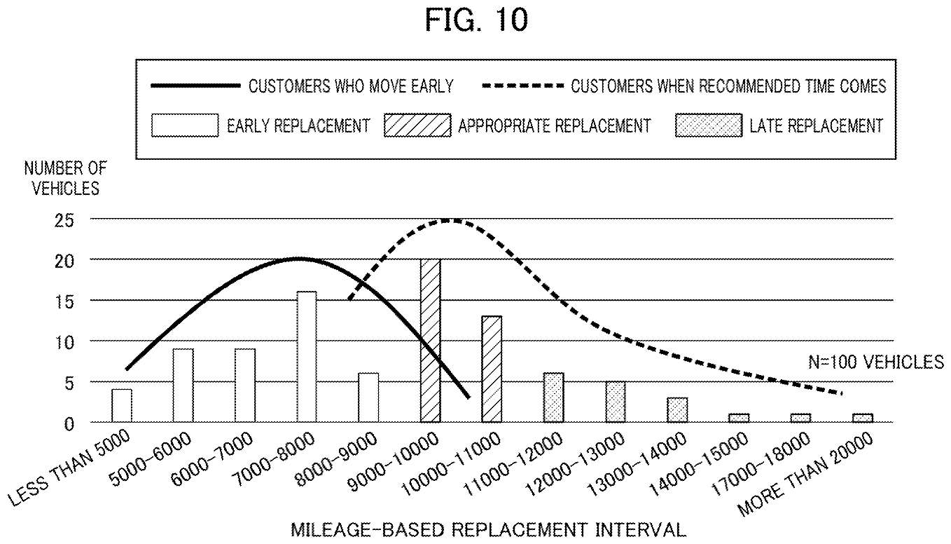

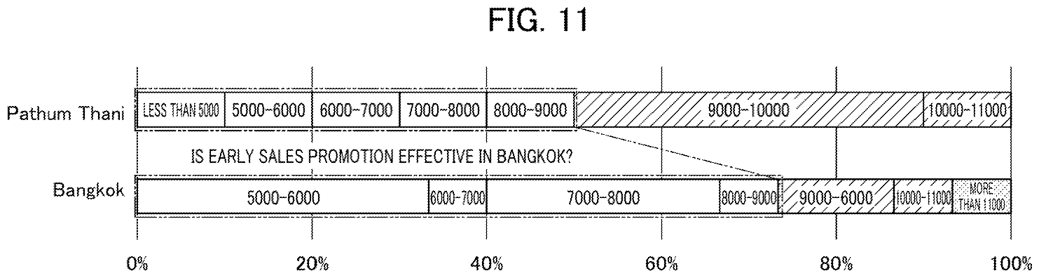

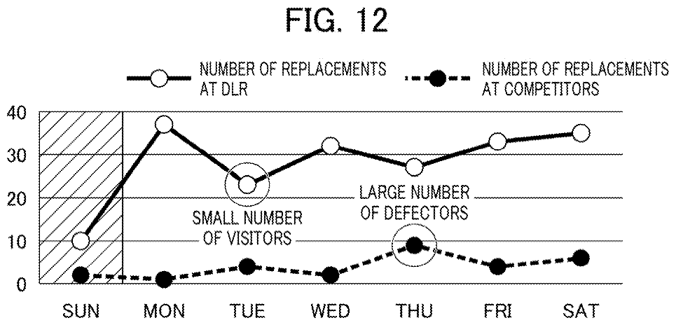

More specifically, for example, as shown in FIG. 9, it becomes possible to obtain the defection rate of customers of vehicles 200 in each city. A shaded part on the right side of the graph for each city in FIG. 9 indicates the defection rate. Further, for example, as shown in FIG. 10, it becomes possible to make it clear at what timing engine oil is replaced relative to the mileage of each vehicle 200. FIG. 10 shows the number of vehicles 200 for which engine oil replacement has been performed relative to mileage in one city. It can be made clear that, in this city, there are many customers who performs replacement early and who performs replacement at an appropriate timing. By performing the above aggregation for different cities, it is seen that the trend in the time to replace engine oil differs between the cities as shown in FIG. 11. Therefore, it becomes possible to reveal whether or not it is desired to perform sales promotion early. Further, it becomes possible to grasp the day of the week when engine oil replacement was performed. Therefore, for example, as shown in FIG. 12, it becomes possible to classify whether a place where engine oil replacement was performed is a dealership of the dealer of the vehicles 200 or a competitor, for each day of the week, and make the classification clear on graphs. Thereby, it becomes possible to make it clear that defection occurs on Tuesdays and Thursdays that are often set as regular holidays of dealerships.

In the present embodiment, the position acquirer 102 acquires the position of each vehicle 200 at the time of restoration to the initial value. Thereby, it becomes possible to grasp the position of the vehicle 200 for which engine oil replacement has been performed.

Further, in the present embodiment, the data receiver 105 receives data of mileage of each vehicle 200, data of the residual rate of engine oil and data of the position of the vehicle 200 at the time of restoration to the initial value. Thereby, it becomes possible to highly accurately calculate the time to replace engine oil next time, using the above data.

Further, in the present embodiment, in the process for receiving data by the data receiver 105, it is possible to use general map information and information with which places where engine oil can be replaced are registered. Thereby, it becomes possible to identify the position of a dealership or the like where engine oil has actually been replaced for each vehicle 200, on the general map information, comparing the position with the general map information. As a result, it becomes possible to highly accurately calculate the time to replace engine oil next time based on the position and mileage of the vehicle 200. Further, it is possible to, for each customer, plot mileage of the vehicle of the customer remaining until the next engine oil replacement on the general map information and register the mileage. Furthermore, it becomes possible to, based on the general map information, calculate more accurate time to replace engine oil and mileage remaining until the replacement in consideration of the customer's driving characteristics about accelerator operations, brake operations and the like and geographical features in the customer's living area.

Further, in the present embodiment, the position of each vehicle 200 as a travel position status is acquired in response to the ignition of the vehicle 200 being turned on; a plurality of places where at least one selected from sales, maintenance and management of the vehicles 200 is performed are registered; and, if an acquired position of the vehicle 200 is different from the registered places, an accurate position is judged by comparison with the general map information. Thereby, it is possible to reflect accurate position information on a map based on the registered places, and it becomes possible to efficiently grasp map data and needs of the customers of the vehicles 200.

Further, in the present embodiment, in the process for judging an accurate position, the map information acquirer 109 adds a place judged by the judger 115 to the general map information and updates the general map information. Thereby, it becomes possible to accurately register a place where engine oil replacement has actually been performed with the general map information.

Further, in the present embodiment, the replacement-time position acquirer 111 acquires the position of each vehicle 200 at the time of engine oil replacement. Thereby, it becomes possible to grasp the position of the vehicle 200 at the time of engine oil replacement, and it becomes possible to grasp whether the position corresponds to the dealership of the vehicle 200 or a competitor.

Further, in the present embodiment, in the process for registering a plurality of places, the place register 108 registers places where engine oil can be replaced. Thereby, it becomes possible to grasp the number of times of and the time to perform engine oil replacement at the registered places where engine oil can be replaced, and it becomes possible to grasp the actual situation of defection of the customers of the vehicles 200, which conventionally has not been seen, in detail for each area. As a result, it becomes possible to develop a customer recapture approach corresponding to the actual situation of each area and lead to increased sales of engine oil as parts of the vehicles 200.

Further, in the present embodiment, the residual rate of engine oil of each vehicle 200 is grasped; a position as a travel position status is acquired in response to the ignition of the vehicle 200 being turned on; replacement of engine oil as a consumable part is detected according to a travel status of the vehicle 200; data of the residual rate of engine oil and data of the position are received; and it is judged whether the owner of the vehicle 200 has changed or not by comparing the residual rate of engine oil and the position of the vehicle 200 at the time of replacing engine oil last time with the residual rate of engine oil and the position of the vehicle 200 at the time of replacing engine oil this time.

Thereby, it becomes possible to, by detecting engine oil replacement, grasp owner change, which conventionally has not been seen, for each vehicle 200. Therefore, it becomes possible to prevent losses and decrease in CSI (customer satisfaction index) due to continuous sales promotion activities for old owners, and it becomes possible to lead to expansion of new development by new sales promotion activities for new owners.

Further, in the present embodiment, in the process for receiving data of the residual rate of engine oil and data of a position, general map information can be used. Thereby, it becomes possible to identify a place where owner has changed on the general map information.

Further, in the present embodiment, in the process for receiving data of the residual rate of engine oil and data of a position, information with which places where engine oil can be replaced are registered can be used. Thereby, it becomes possible to grasp a relationship between a place where owner has changed and a place where engine oil can be replaced.

Further, in the present embodiment, in the process for judging whether the owner has changed or not, the owner change judger 113 detects that the owner of each vehicle 200 has changed subject to a requirement being satisfied that engine oil replacement positions are the same, and time between engine oil replacement last time and engine oil replacement this time is shorter than a predetermine time. Thereby, it is possible to easily judge whether the owner has changed or not.

The present invention is not limited to the above embodiment, and modifications, improvements and the like within a range that the object of the present invention can be achieved are included in the invention. For example, though the movable body is a vehicle 200, and the consumable part is engine oil in the present embodiment, the present invention is not limited thereto. For example, the movable body may be any of vehicles in general that are mounted with an engine and use engine oil. Further, for example, the consumable part may be a battery, a tire or the like. For example, in the case of a tire, a change in the diameter of the tire can be detected to grasp a consumption status of the tire as a consumable part.

Further, though the position acquirer 102 acquires information about the position of each vehicle 200, which is a travel position status at the time of the ignition being turned on in the vehicle 200 in the present embodiment, the present invention is not limited thereto. For example, the position acquirer 102 may acquire information about the position of each vehicle 200, which is a travel position status at the time of the ignition being turned off in the vehicle 200. In this case, the mileage acquirer 103 can acquire mileage of each vehicle 200 at the time of the ignition being turned off in the vehicle 200, which is included in vehicle data acquired from the vehicle 200. Further, the data receiver 105 can receive data of mileage of each vehicle 200 at the time of the ignition being turned on in the vehicle 200, from the position acquirer 102, and data of mileage of the vehicle 200 at the time of the ignition being turned off in the vehicle 200, from the mileage acquirer 103, which is included in the vehicle data acquired from the vehicle 200. Further, the owner change judger 113 can detect whether the owner of each vehicle 200 has changed or not based on a difference time between the time stamp at the time of the ignition being turned off and the time stamp of the ignition being turned off next.

Further, though the replacement-time mileage calculator 104 determines a date when the value of the residual rate of engine oil is predicted to be restored to the initial value next time, that is, a date when engine oil is predicted to be replaced next time in the present embodiment, the present invention is not limited to this configuration. For example, the replacement-time mileage calculator 104 may determine only mileage remaining until the value of the residual rate of engine oil is restored to the initial value next time, that is, until the time when engine oil is predicted to be replaced next time, without determining a date.

Further, in addition to the configuration of the present embodiment, such a configuration may also be provided that, in order to efficiently perform inspection and replacement of a consumable part, a sensor is utilized to urge the inspection and replacement.

Further, the replacement-time mileage calculator 104 may be adapted to derive a more accurate expected replacement date, taking into account the driving characteristics (about acceleration and braking) of a vehicle customer, in addition to the configuration of the present embodiment.

### EXPLANATION OF REFERENCE NUMERALS

1 System

100 Control processing apparatus

101 Engine oil residual rate acquirer (consumable part consumption degree grasper)

102 Position acquirer

103 Mileage acquirer

104 Replacement-time mileage calculator

105 Data receiver

106 Replacement place register

107 Replacement place identifier

108 Place register

109 Map information acquirer

110 Position judger

111 Replacement-time position acquirer

112 Oil replacement detector (consumable part replacement detector)

113 Owner change judger

114 Average mileage calculator

115 Judger

200-1 to 200-n Vehicle

What is claimed is:

1. A consumable part replacement time calculation system comprising:
a mileage acquirer acquiring mileage in response to an ignition of a movable body being turned on or off;
a consumable part consumption degree grasper grasping a consumption status of a consumable part provided in the movable body;
an average mileage calculator calculating, when a value of data from the consumable part consumption degree grasper has been restored to an initial value a plurality of times, an average value of mileage between two adjacent restorations to the initial value; and
a replacement-time mileage calculator calculating replacement time of the consumable part by dividing total mileage traveled by the movable body by the number of times of the value of the data from the consumable part consumption degree grasper having been restored to the initial value.

2. The consumable part replacement time calculation system according to claim 1, comprising a position acquirer acquiring a position of the movable body at a time of replacement of the consumable part.

3. The consumable part replacement time calculation system according to claim 2, comprising a data receiver receiving data from the mileage acquirer, the data from the consumable part consumption degree grasper, and data from the position acquirer.

4. The consumable part replacement time calculation system according to claim 3, wherein the data receiver includes general map information and a replacement place register with which places where replacement of the consumable part is possible are registered in advance.

5. The consumable part replacement time calculation system according to claim 1, wherein the replacement-time mileage calculator calculates the replacement time of the consumable part as at least one selected from the mileage of the movable body and a date.

6. A consumable part replacement time calculation method comprising the steps of:
acquiring mileage in response to an ignition of a movable body being turned on or off;
grasping a consumption status of a consumable part provided in the movable body;
calculating, when a value of data of the consumption status of the consumable part has been restored to an initial value a plurality of times, an average value of mileage between two adjacent restorations to the initial value; and
calculating replacement time of the consumable part by dividing total mileage traveled by the movable body by the number of times of the value of the data of the consumption status of the consumable part having returned to the initial value.

7. The consumable part replacement time calculation method according to claim 6, comprising a step of acquiring a position of the movable body at a time of restoration to the initial value.

8. The consumable part replacement time calculation method according to claim 6, comprising a step of receiving data of the mileage, the data of the consumption status of the consumable part, and data of a position of the movable body at a time of restoration to the initial value.

9. The consumable part replacement time calculation method according to claim 8, wherein, in the receiving step, it is possible to use general map information and information with which places where replacement of the consumable part is possible are registered.

10. The consumable part replacement time calculation method according to claim 6, wherein the replacement time of the consumable part is calculated as at least one selected from the mileage of the movable body and a date.
